(19) United States
(12) Patent Application Publication
(10) Pub. No.: US 2023/0325911 A1
(43) Pub. Date: Oct. 12, 2023

(54) MANAGEMENT SYSTEM FOR HOURLY RENTAL FACILITIES

(71) Applicant: TAISHO SKY BUILDING, INC., Tokyo (JP)

(72) Inventor: Kazuharu Ishida, Tokyo (JP)

(21) Appl. No.: 18/334,654

(22) Filed: Jun. 14, 2023

Related U.S. Application Data
(63) Continuation of application No. PCT/JP2020/047659, filed on Dec. 21, 2020.

(51) Int. Cl. G06Q 30/0645; G06Q 10/02; G06Q 10/0637

(52) U.S. Cl. CPC G06Q 30/0645; G06Q 10/02; G06Q 10/0637

(57) ABSTRACT

A management system for the on-demand rental facility includes a management server for managing the on-demand rental facility, an administrator side terminal device, and a user side terminal device. The management server includes: a management side reservation manager that sets management side reservation information on a user and use date and time of the on-demand rental facility by receiving reservation of the on-demand rental facility via the user side terminal device; a reservation information annunciator that announces the management side reservation information to an administrator of the on-demand rental facility; and a user group setter that causes the administrator of the on-demand rental facility to set, via the administrator side terminal device, a group of users who are persons eligible for the reservation of the on-demand rental facility.

### RELATED APPLICATIONS

The present application is a continuation of International Patent Application No. PCT/JP2020/047659 (filed Dec. 21, 2020), which is hereby incorporated by reference in its entirety.

### TECHNICAL FIELD

The present disclosure relates to a management system for an on-demand rental facility.

### BACKGROUND

Conventionally, a system for renting an empty conference room of a building, an office, a hotel, or the like to general users has been proposed. For example, a conventional rental system may include a management server open to a communication network such as the Internet and a plurality of reservation servers in which information on the conference room is stored. The user can access conference room information in the reservation server via the management server and reserve a desired conference room. In addition, the rental system also has a billing function so that a rental fee can be paid online. In such a rental system, in order to rent an empty conference room to more users, basic information such as an available time of day, the number of users, and a usage fee of the conference room is disclosed to the users.

However, since the above-mentioned basic information is set for each empty conference room regardless of a rental status of the empty conference room, there is a problem that when business goals (goals such as sales and occupancy rate) of the rental system cannot be achieved, the basic information must be reset for each empty conference room on the basis of reservation information of the empty conference room.

### SUMMARY

An object of the present disclosure is to provide a management system for an on-demand rental facility that can support achievement of the business goals of the on-demand rental facility on the basis of the reservation information of the on-demand rental facility.

The management system for the on-demand rental facility of the present disclosure is a management system for the on-demand rental facility, including: a management server that manages the on-demand rental facility; an administrator input unit that is connected to the management server via a communication line and receives information input to the management server by an administrator of the on-demand rental facility; and a user input unit that is connected to the management server via a communication line and receives information input to the management server by a user of the on-demand rental facility, in which the management server includes: a management side reservation manager that stores and sets management side reservation information on the user and use date and time of the on-demand rental facility in a management information storage by receiving a reservation for the on-demand rental facility via the user input unit; a reservation information annunciator that announces the management side reservation information stored in the management information storage by the management side reservation manager to the administrator of the on-demand rental facility; and a user group setter that causes the administrator of the on-demand rental facility to set, via the administrator input unit, a group of users who are persons eligible for the reservation of the on-demand rental facility to be received via the user input unit, and the group of users includes: a first group of users; and a second group of users different from the first group of users.

With such a configuration, the management server includes: the reservation information annunciator that announces the management side reservation information stored in the management information storage by the management side reservation manager to the administrator of the on-demand rental facility; and the user group setter that causes the administrator of the on-demand rental facility to set, via the administrator input unit, the group of users who are persons eligible for the reservation of the on-demand rental facility to be received via the user input unit, and thus the administrator of the on-demand rental facility can set the group of users by the user group setter so that the business goals (goals such as sales and occupancy rate) of the on-demand rental facility can be achieved on the basis of the management side reservation information announced by the reservation information annunciator. Therefore, the management system for the on-demand rental facility can support the achievement of the business goals of the on-demand rental facility.

In the present disclosure, a usage fee of the on-demand rental facility for the first group of users and a usage fee of the on-demand rental facility for the second group of users are preferably different from each other.

With such a configuration, since the administrator of the on-demand rental facility can change the usage fee of the on-demand rental facility by setting the group of users by the user group setter, the user group setter can set the group of users so that the business goals of the on-demand rental facility can be achieved.

In the present disclosure, one of the first group of users and the second group of users is preferably a group of subscription users who pay a fee as consideration for usage right for a certain period.

With such a configuration, even when it is not possible to increase the occupancy rate of the on-demand rental facility with normal pricing, the occupancy rate of the on-demand rental facility can be increased by setting the group of subscription users by the user group setter.

In the present disclosure, the management server preferably includes: a business goal information setter that stores and sets, by receiving business goals of the on-demand rental facility via the administrator input unit, business goal information on the business goals, in the management information storage; a business goal achievement determiner that determines whether the business goals can be achieved on the basis of the management side reservation information and the business goal information; and a user group switcher that causes the user group setter to switch the group of users on the basis of a determination result of the business goal achievement determiner.

With such a configuration, since the user group switcher causes the user group setter to switch the group of users on the basis of the determination result of the business goal achievement determiner, the management system for the on-demand rental facility can automatically switch the group of users so that the business goals of the on-demand rental facility can be achieved.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a schematic configuration diagram of a management system for a rental space according to an implementation of the present disclosure.

FIG. 2 is a functional block diagram illustrating a schematic configuration of the management system for the rental space.

FIG. 3 is a functional block diagram illustrating a customer attraction server and a site controller in the schematic configuration of the management system for the rental space.

FIG. 4 is a flowchart illustrating an operation of reservation information management processing in a management server, the customer attraction server, and the site controller.

FIG. 5 is a flowchart illustrating an operation of reservation information announcement processing on the management server.

FIG. 6 is a flowchart illustrating an operation of user group setting processing on the management server.

FIG. 7 is a flowchart illustrating an operation of business goal setting determination processing on the management server.

### DETAILED DESCRIPTION

Hereinafter, implementations of the present disclosure will be described with reference to the drawings.

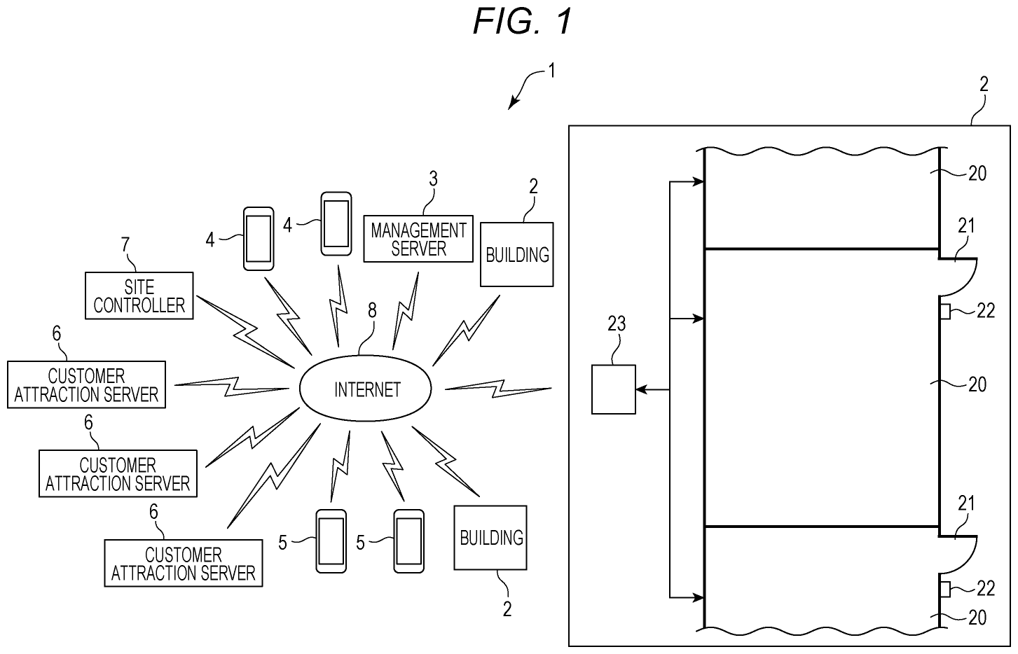

FIG. 1 is a schematic configuration diagram of a management system for a rental space according to an implementation of the present disclosure.

As illustrated in FIG. 1, a management system 1 for the rental space is a system that manages the rental space (on-demand rental facility), in which a predetermined space is rented on the basis of reservation information on a user and use date and time. The management system 1 for the rental space includes a building 2 with rooms 20 as a plurality of rental spaces, a management server 3 for managing the building 2, an administrator side terminal device 4 as an administrator input unit such as a mobile phone, a smartphone, or a personal computer possessed by the administrator of the building 2, and a user side terminal device 5 as a user input unit such as a mobile phone, a smartphone, or a personal computer possessed by the user who wishes to use the room 20. Further, the management system 1 for the rental space includes a plurality of customer attraction servers 6 for attracting users and reserving use of the room 20, and a site controller 7 that synchronizes the reservation information between the management server 3 and the customer attraction servers 6. The building 2, the management server 3, the administrator side terminal device 4, the user side terminal device 5, the customer attraction servers 6, and the site controller 7 are connected to each other so as to be able to communicate with each other via the Internet 8 which is a public network as a communication line.

As described above, the building 2 includes a plurality of rooms 20, and each room 20 includes a doorway 21 and a locking device 22 for locking and unlocking the doorway 21. The locking device 22 can be unlocked by an unlocking key such as a password or an optical code such as a bar code or a QR code (registered trademark) issued from the site controller 7 to the user side terminal device 5. The unlocking key is randomly changed each time it is used, and the user who has made a reservation at that time can unlock the locking device 22 by using a unique unlocking key. Each room 20 includes a communication terminal device 23 such as a modem or a router connected via a local area network (LAN). The communication terminal device 23 is connected to the management server 3 via the Internet 8.

Here, the management server 3 manages a plurality of buildings 2 and meets specifications of the locking device 22 of the room 20 in each building 2. Further, the site controller 7 meets the specifications of the locking device 22 of the room 20 in each building 2 managed by the management server 3. In other words, the site controller 7 can issue the unlocking key corresponding to the locking device 22 of the room 20 in each building 2.

Note that in the present implementation, the password, the optical code such as the bar code or the QR code (registered trademark), or the like is employed as the unlocking key, but for example, biometric authentication such as face authentication, fingerprint authentication, or retinal authentication may be employed, and any unlocking key may be employed as long as it can unlock the locking device 22.

Further, the site controller 7 may be capable of synchronizing the reservation information between the plurality of management servers 3 and the plurality of customer attraction servers 6.

The user can access the management server 3 or the customer attraction server 6 via the Internet 8 using the user side terminal device 5, search for the room 20 desired to be used, and specify a usage time to make a reservation for use. When the management server 3 or the customer attraction server 6 receives the reservation from the user, the management server 3 or the customer attraction server 6 transmits the reservation information including the user and reservation date and time (usage start time and usage end time) of the room 20, for which the reservation has been confirmed, to the site controller 7.

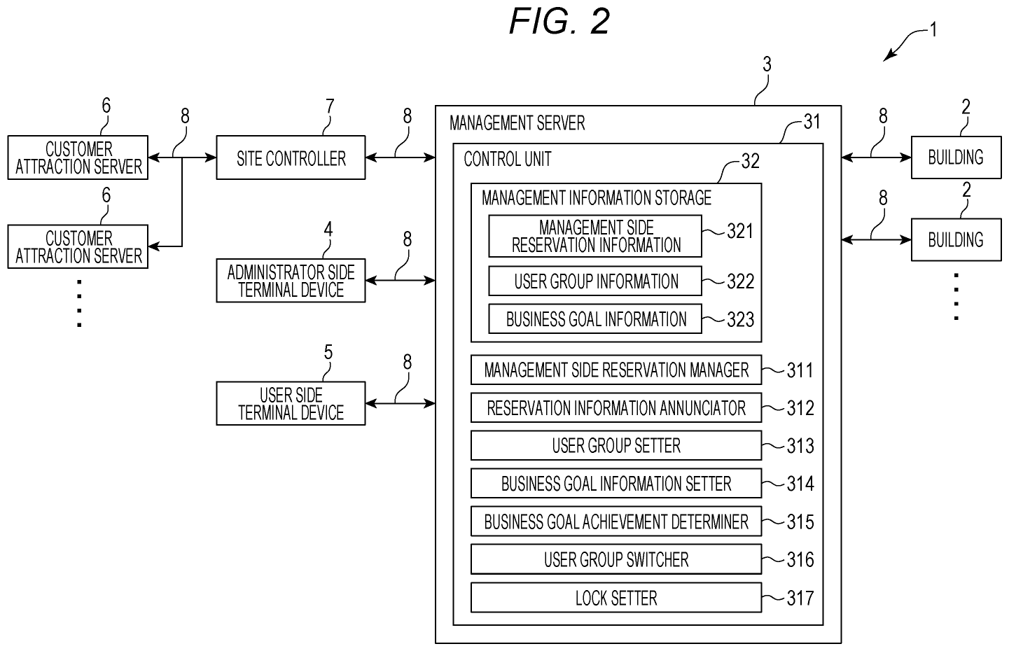

FIG. 2 is a functional block diagram illustrating a schematic configuration of the management system for the rental space.

The management server 3 includes a control unit 31 including a central processing unit (CPU), a memory, and the like, and executing information processing according to a predetermined program stored in the memory. The control unit 31 includes a management information storage 32, a management side reservation manager 311, a reservation information annunciator 312, a user group setter 313, a business goal information setter 314, a business goal achievement determiner 315, a user group switcher 316, and a lock setter 317.

Note that each function of the control unit 31 is executed according to the program stored in the management information storage 32, but each function may be configured by an independent device or may be configured by cloud computing.

In addition to storing various programs, the management information storage 32 stores management side reservation information 321 on the user and use date and time of the room 20, user group information 322 on a group of users who are persons eligible for the reservation of the room 20 to be received, and business goal information 323 on business goals of the room 20.

Note that the management information storage 32 includes the memory of the control unit 31, but may include a hard disk drive (HDD), a network attached storage (NAS), or the like, or may include a cloud service.

Upon receiving the reservation of the room 20 via the user side terminal device 5, the management side reservation manager 311 stores and sets, in the management information storage 32, the management side reservation information 321 on the user and use date and time of the room 20.

The reservation information annunciator 312 announces the management side reservation information 321 stored in the management information storage 32 to the administrator of the room 20 by the management side reservation manager 311. Specifically, the reservation information annunciator 312 announces the management side reservation information 321 to the administrator of the room 20 by transmitting the management side reservation information 321 to the administrator side terminal device 4.

The user group setter 313 causes, via the administrator side terminal device 4, the administrator of the room 20 to set the group of users who are persons eligible for the reservation of the room 20 to be received via the user side terminal device 5. Specifically, the user group setter 313 causes the administrator of the room 20 to set one or a plurality of user groups among the user group information 322 stored in advance in the management information storage 32 via the administrator side terminal device 4.

Here, in the present implementation, the user group information 322 includes two types of user groups of general members (a first group of users), and of subscription members (a second group of users) who pay a fee as consideration for usage right for a certain period. Note that in the present implementation, the user can be registered in duplicate as the general member and the subscription member, but the user may not be able to be registered in duplicate.

Then, the general member is a member who pays the consideration for the reservation each time the room 20 is reserved, whereas the subscription member is a member who pays a specified monthly fee or an annual fee in advance and thus does not have to pay the consideration for the reservation each time the room 20 is reserved. In other words, the usage fee of the room 20 for the general member and the usage fee of the room 20 for the subscription member are different from each other.

In the present implementation, the user group information 322 has two types of user groups, but may have three or more types of user groups. Further, the user group information 322 may include a different group of users from general members and subscription members, such as for example, paid members who can pay a predetermined membership fee to receive a discount on the usage fee or receive benefits when using the room, or very important person (VIP) members who frequently use the room. Here, the paid members and the VIP members may be divided into a plurality of classes. Further, the user group information 322 may include a user group in which the users are classified according to attributes of the user, such as birthday and gender.

Further, in the present implementation, the usage fee of the on-demand rental facility for the first group of users and the usage fee of the on-demand rental facility for the second group of users are different from each other, but the usage fees may not be different from each other, and the user group may be classified on the basis of conditions different from the usage fee. In short, the user group is only required to include the first group of users and the second group of users different from the first group of users.

The business goal information setter 314 receives the business goals of the room 20 via the administrator side terminal device 4, and thus stores and sets the business goal information 323 on the business goals in the management information storage 32. Here, the business goals are goals such as the sales and the occupancy rate of the room 20.

The business goal achievement determiner 315 determines whether the business goals can be achieved on the basis of the management side reservation information 321 and the business goal information 323 stored in the management information storage 32.

The user group switcher 316 causes the user group setter 313 to switch the user group on the basis of a determination result of the business goal achievement determiner 315. Specifically, when the business goal achievement determiner 315 determines that the business goals can be achieved, the user group switcher 316 causes the user group setter 313 to switch the user group to the general member. At this time, the user group setter 313 cancels setting of the user group of subscription members. Further, when the business goal achievement determiner 315 determines that the business goals cannot be achieved, the user group switcher 316 causes the user group setter 313 to switch the user group to the subscription member. At this time, the user group setter 313 may register the general member and the subscription member in duplicate without canceling the setting of the user group of general members, or may cancel the setting of the user group of general members.

The lock setter 317 sets the locking device 22 of the room 20.

Specifically, when the usage start time included in the management side reservation information 321 stored in the management information storage 32 is reached, or shortly before the usage start time (for example, 10 minutes before the usage start time), the lock setter 317 sets the unlocking key corresponding to the management side reservation information 321 in the locking device 22 of the room 20.

Further, when the usage end time included in the management side reservation information 321 stored in the management information storage 32 has passed, or shortly after the usage end time (for example, 10 minutes after the usage end time), the lock setter 317 sets an unlocking key different from the unlocking key corresponding to the management side reservation information 321 in the locking device 22 of the room 20.

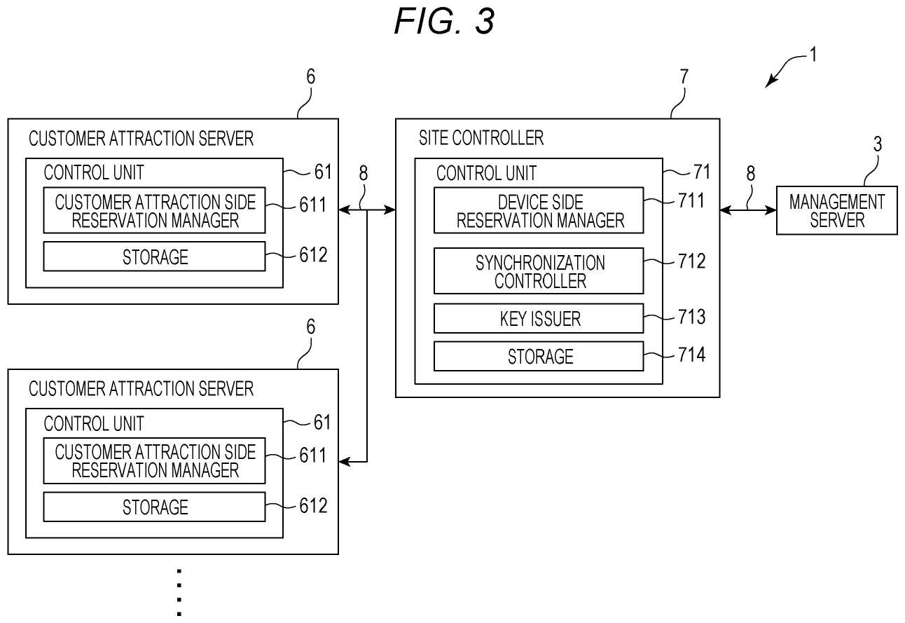

FIG. 3 is a functional block diagram illustrating the customer attraction server and the site controller in the schematic configuration of the management system for the rental space.

The customer attraction server 6 includes a control unit 61 including a CPU, a memory, and the like, and executing information processing according to a predetermined program stored in the memory.

The control unit 61 includes a customer attraction side reservation manager 611 and a storage 612.

The customer attraction side reservation manager 611 stores and manages customer attraction side reservation information including the usage start time and the usage end time set by the reservation in the storage 612.

The site controller 7 functions as an information processing apparatus for setting the usage time and allowing the user to use the room 20, and includes a control unit 71 including a CPU, a memory, and the like, and executing information processing according to a predetermined program stored in the memory.

The control unit 71 includes a device side reservation manager 711, a synchronization controller 712, a key issuer 713, and a storage 714.

The device side reservation manager 711 stores and manages the device side reservation information including the usage start time and the usage end time set by the reservation in the storage 714.

The synchronization controller 712 synchronizes the reservation information (the management side reservation information 321 and the customer attraction side reservation information) between the management server 3 and the customer attraction server 6.

The key issuer 713 issues the unlocking key corresponding to the locking device 22 of the room 20 in each building 2.

Note that the storages 612 and 714 include the memories of the control units 61 and 71, but may include the HDD, the NAS, or the like, or may include the cloud service.

Further, functions of the control units 61 and 71 are executed according to the programs stored in the storages 612 and 714, but may be configured by independent devices, or may be configured by cloud computing.

<Reservation Information Management Processing>

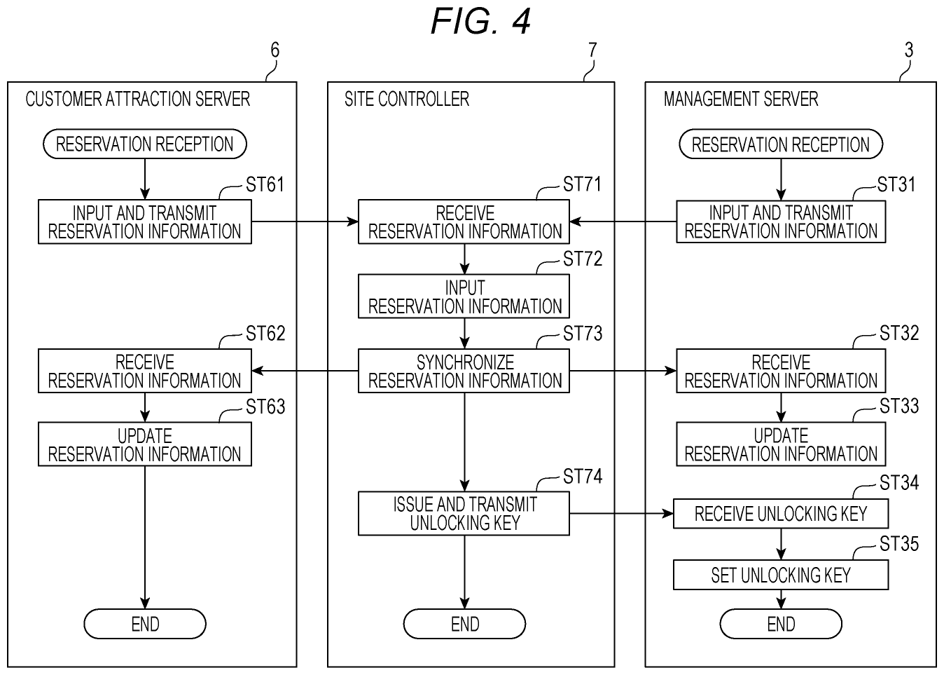

FIG. 4 is a flowchart illustrating an operation of reservation information management processing in the management server, the customer attraction server, and the site controller.

As illustrated in FIG. 4, the control units 31, 61, and 71 of the management server 3, the customer attraction server 6, and the site controller 7 execute various processing of Steps ST31 to ST35, ST61 to ST63, and ST71 to ST74 according to the predetermined programs stored in the memories.

As described above, the user can access the management server 3 or the customer attraction server 6 via the Internet 8 using the user side terminal device 5, search for the room 20 desired to be used, and specify the usage time to make a reservation for use.

Note that in the present implementation, it is configured so that the user can access the management server 3 or the customer attraction server 6 via the Internet 8 using the user side terminal device 5, search for the room 20 desired to be used, and specify the usage time to make a reservation for use, but it may be configured so that the user can make a reservation for use only in one of the management server 3 and the customer attraction server 6.

Upon receiving the reservation from the user, the management side reservation manager 311 of the management server 3 inputs and stores the management side reservation information 321 including the user and the reservation date and time of the room 20, for which the reservation has been confirmed, in the management information storage 32, and transmits the management side reservation information 321 to the site controller 7 via the Internet 8 (Step ST31).

Further, upon receiving the reservation from the user, the customer attraction side reservation manager 611 of the customer attraction server 6 inputs and stores the customer attraction side reservation information including the user and the reservation date and time of the room 20, for which the reservation has been confirmed, in the storage 612, and transmits the customer attraction side reservation information to the site controller 7 via the Internet 8 (Step ST61).

When the reservation information is transmitted from the management server 3 or the customer attraction server 6, the device side reservation manager 711 of the site controller 7 receives the reservation information (Step ST71).

Upon receiving the reservation information from the management server 3 or the customer attraction server 6, the device side reservation manager 711 of the site controller 7 inputs and stores the reservation information as the device side reservation information in the storage 714 (Step ST72). In other words, the device side reservation manager 711 functions as an information obtainer for obtaining an update of the customer attraction side reservation information of the customer attraction server 6 and an update of the management side reservation information of the management server 3.

Then, the synchronization controller 712 of the site controller 7 transmits the device side reservation information stored in the storage 714 to the management server 3 and the customer attraction server 6, and synchronizes the reservation information between the management server 3 and the customer attraction server 6 (Step ST73).

Upon receiving the reservation information from the site controller 7 (Step ST32), the management side reservation manager 311 of the management server 3 inputs and stores the reservation information as the management side reservation information 321 in the management information storage 32, and thus updates the management side reservation information 321 stored in the management information storage 32 (Step ST33).

Further, upon receiving the reservation information from the site controller 7 (Step ST62), the customer attraction side reservation manager 611 of the customer attraction server 6 inputs and stores the reservation information as the customer attraction side reservation information in the storage 612, and thus updates the customer attraction side reservation information stored in the storage 612 (Step ST63).

By executing these steps, the reservation information stored in the management server 3 and all the customer attraction servers 6 match each other.

After transmitting the device side reservation information stored in the storage 714 to the management server 3 and the customer attraction server 6, the key issuer 713 of the site controller 7 issues the unlocking key corresponding to the locking device 22 of the room 20 related to the device side reservation information, and transmits the unlocking key in association with the device side reservation information to the management server 3 and the user side terminal device 5 (Step ST74). In other words, the key issuer 713 issues the unlocking key for unlocking the locking device 22 of the room 20 when the device side reservation manager 711 obtains the update of the customer attraction side reservation information.

Upon receiving the unlocking key from the site controller 7 (Step ST34), the management side reservation manager 311 of the management server 3 stores the unlocking key as the unlocking key corresponding to the management side reservation information 321 stored in the management information storage 32 on the basis of the device side reservation information associated with the unlocking key.

Then, when the usage start time included in the management side reservation information 321 is reached, or shortly before the usage start time (for example, 10 minutes before the usage start time), the lock setter 317 of the management server 3 sets the unlocking key corresponding to the management side reservation information 321 in the locking device 22 of the room 20 (Step ST35). Thus, the user can unlock the locking device 22 of the room 20 and enter the room 20 by using the unlocking key transmitted from the site controller 7.

Note that when the usage end time included in the management side reservation information 321 has passed, or slightly after the usage end time (for example, 10 minutes after the usage end time), the lock setter 317 of the management server 3 sets the unlocking key different from the unlocking key corresponding to the management side reservation information 321 in the locking device 22 of the room 20. Thus, the user cannot re-enter the room 20.

Here, the customer attraction server 6 includes a billing unit capable of paying the usage fee of the room 20 online. Further, the customer attraction server 6 includes a difference payment unit for paying the administrator of the room 20 a difference obtained by subtracting a usage fee of the customer attraction server 6 from the usage fee of the room 20 paid online.

Further, the difference payment unit is configured so that the usage fee of the customer attraction server 6 can be set as a fixed fee or a fee of a predetermined ratio (0 to 100%) to the usage fee of the room 20. In other words, the difference payment unit can make the consideration paid to the administrator of the room 20 zero.

Thus, for example, a provider of the customer attraction server 6 can diversify a method of providing the room 20, such as allowing the user to use the room 20 free of charge for a fixed period.

<Reservation Information Announcement Processing>

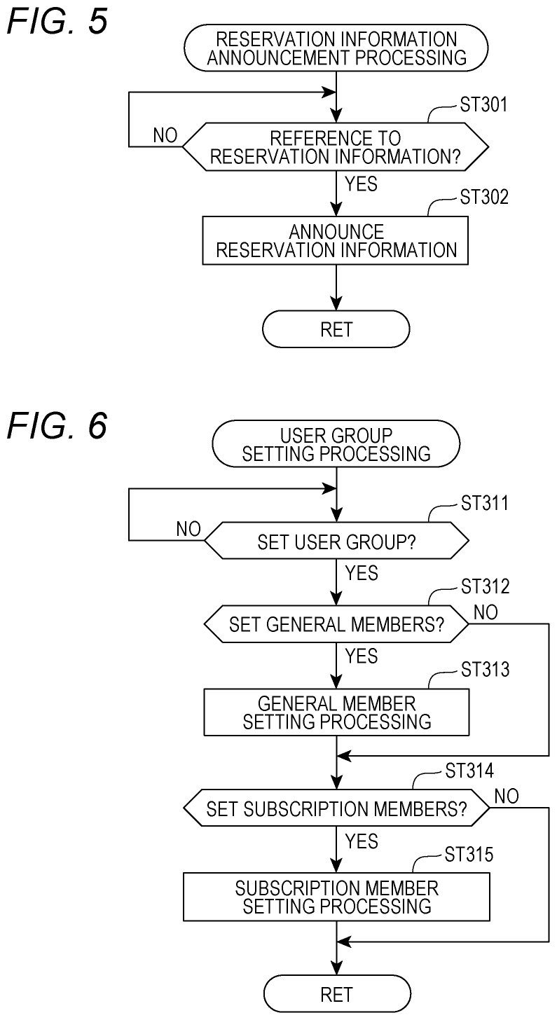

FIG. 5 is a flowchart illustrating an operation of reservation information announcement processing on the management server.

As illustrated in FIG. 5, the control unit 31 of the management server 3 executes the reservation information announcement processing of Steps ST301 to ST302 according to the predetermined program stored in the memory.

The administrator can access the management server 3 via the Internet 8 using the administrator side terminal device 4, and refer to the management side reservation information 321 stored in the management information storage 32 by the management side reservation manager 311.

In the reservation information announcement processing, the reservation information annunciator 312 determines whether reference to the management side reservation information 321 has been requested via the administrator side terminal device 4 (Step ST301).

When the reservation information annunciator 312 determines in Step ST301 that the reference to the management side reservation information 321 is not requested, processing of Step ST301 is executed again.

On the other hand, when the reservation information annunciator 312 determines in Step ST301 that the reference to the management side reservation information 321 is requested, the reservation information annunciator 312 announces the management side reservation information 321 stored in the management information storage 32 by the management side reservation manager 311 to the administrator of the room 20 in Step ST302. Specifically, the reservation information annunciator 312 announces the management side reservation information 321 to the administrator of the room 20 by transmitting the management side reservation information 321 to the administrator side terminal device 4. Thereafter, the control unit 31 of the management server 3 executes the reservation information announcement processing again.

<User Group Setting Processing>

FIG. 6 is a flowchart illustrating an operation of user group setting processing on the management server.

As illustrated in FIG. 6, the control unit 31 of the management server 3 executes the user group setting processing of Steps ST311 to ST315 according to the predetermined program stored in the memory.

In the user group setting processing, the user group setter 313 determines whether setting of the user group has been requested via the administrator side terminal device 4 (Step ST311).

If it is determined in Step ST311 that the setting of the user group is not requested, the user group setter 313 executes the processing of Step ST311 again.

On the other hand, if it is determined in Step ST311 that the setting of the user group has been requested, the user group setter 313 determines in Step ST312 whether the setting of the user group of general members has been requested among the user group information 322 stored in advance in the management information storage 32.

If it is determined that the setting of the user group of general members has been requested in Step ST312, the user group setter 313 executes general member setting processing in Step ST313. In the general member setting processing, the user group setter 313 sets (registers or cancels) the user group of general members as the group of users who are persons eligible for the reservation of the room 20 to be received via the user side terminal device 5.

After executing the general member setting processing of Step ST313, or if it is determined in Step ST312 that the setting of the user group of general members is not requested, the user group setter 313 determines in Step ST314 whether the setting of the user group of subscription members has been requested among the user group information 322 stored in advance in the management information storage 32.

If it is determined in Step ST314 that the setting of the user group of subscription members has been requested, the user group setter 313 executes subscription member setting processing in Step ST315. In the subscription member setting processing, the user group setter 313 sets (registers or cancels) the user group of subscription members as the group of users who are persons eligible for the reservation of the room 20 to be received via the user side terminal device 5.

After executing the subscription member setting processing of Step ST315, or if it is determined in Step ST314 that the setting of the user group of subscription members is not requested, the control unit 31 of the management server 3 executes the user group setting processing again.

<Business Goal Setting Determination Processing>

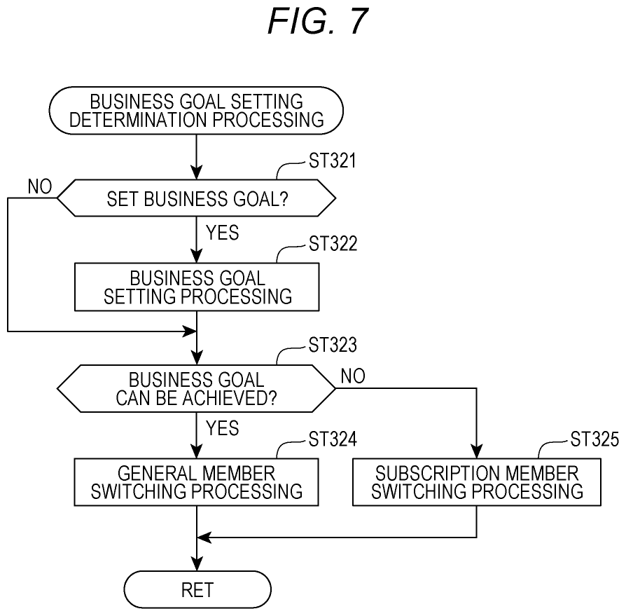

FIG. 7 is a flowchart illustrating an operation of business goal setting determination processing on the management server.

As illustrated in FIG. 7, the control unit 31 of the management server 3 executes the business goal setting determination processing of Steps ST321 to ST325 according to a predetermined program stored in the memory.

In the business goal setting determination processing, the business goal information setter 314 determines whether setting of the business goals has been requested via the administrator side terminal device 4 (Step ST321).

If it is determined in Step ST321 that the setting of the business goals is not requested, the business goal information setter 314 executes processing of Step ST323 and the followings, which will be described below.

On the other hand, if it is determined in Step ST321 that the setting of the business goals has been requested, the business goal information setter 314 executes the business goal setting determination processing in Step ST322. In the business goal setting determination processing, the business goal information setter 314 receives the business goals of the room 20 via the administrator side terminal device 4, and thus stores and sets the business goal information 323 on the business goals in the management information storage 32. Here, the business goals are goals such as the sales and the occupancy rate of the room 20.

After executing the business goal setting determination processing of Step ST322, or if it is determined in Step ST321 that the setting of the business goals is not requested, the business goal achievement determiner 315 determines in Step ST323 whether the business goals can be achieved on the basis of the management side reservation information 321 and the business goal information 323 stored in the management information storage 32. For example, the business goal achievement determiner 315 grasps the occupancy rate of the room 20 on the basis of the current management side reservation information 321, and forecasts the sales of the room 20 in a predetermined period (one day, one week, one month, or the like). Then, sales forecast in this predetermined period is compared with the business goal information 323, and it is determined whether the business goals can be achieved.

Note that in the present implementation, the business goal achievement determiner 315 compares the sales forecast with the business goal information 323 and determines whether the business goals can be achieved, but for example, it may be determined whether the business goals can be achieved on the basis of, for example, only an operational status of the room 20, or it may be determined whether the business goals can be achieved on the basis of other conditions. In short, the business goal achievement determiner is only required to determine whether the business goals can be achieved on the basis of the management side reservation information and the business goal information stored in the management information storage.

When it is determined in Step ST323 that the business goals can be achieved, the user group switcher 316 executes general member switching processing in Step ST324. In the general member switching processing, the user group setter 313 sets the user group of general members as the group of users who are persons eligible for the reservation of the room 20 to be received via the user side terminal device 5. At this time, the user group setter 313 cancels the setting of the user group of subscription members.

On the other hand, if it is determined in Step ST323 that the business goals cannot be achieved, the user group switcher 316 executes subscription member switching processing in Step ST325. In the subscription member switching processing, the user group setter 313 sets the user group of subscription members as the group of users who are persons eligible for the reservation of the room 20 to be received via the user side terminal device 5. At this time, the user group setter 313 may register the general member and the subscription member in duplicate without canceling the setting of the user group of general members, or may cancel the setting of the user group of general members.

Note that the user group switcher 316 may specify a predetermined period (one day, one week, one month, or the like) and set the user group of general members or the user group of subscription members, and in this case, the setting of various user groups can be canceled after expiration of the predetermined period.

According to the present implementation described above, the following operations and effects can be obtained.

(1) The management server 3 includes: the reservation information annunciator 312 that announces the management side reservation information 321 stored in the management information storage 32 by the management side reservation manager 311 to the administrator of the room 20; and the user group setter 313 that causes the administrator of the room 20 to set, via the administrator side terminal device 4, the group of users who are persons eligible for the reservation of the room 20 to be received via the user side terminal device 5, and thus the administrator of the room 20 can set the group of users by the user group setter 313 so that the business goals (goals such as sales and occupancy rate) of the room 20 can be achieved on the basis of the management side reservation information 321 announced by the reservation information annunciator 312. Therefore, the management system 1 for the rental space can support the achievement of the business goals of the room 20.

(2) Since the administrator of the room 20 can change the usage fee of the room 20 by setting the group of users by the user group setter 313, the user group setter 313 can set the group of users so that the business goals of the room 20 can be achieved.

(3) Even when it is not possible to increase the occupancy rate of the room 20 with pricing of the general member, the occupancy rate of the room 20 can be increased by setting the user group of subscription members by the user group setter 313.

(4) Since the user group switcher 316 causes the user group setter 313 to switch the group of users on the basis of the determination result of the business goal achievement determiner 315, the management system 1 for the rental space can automatically switch the group of users so that the business goals of the room 20 can be achieved.

(5) The site controller 7 is connected to the management server 3 and the customer attraction server 6 via the Internet 8, obtains the update of the customer attraction side reservation information of the customer attraction server 6 received via the user side terminal device 5, and the update of the management side reservation information of the management server 3 by the device side reservation manager 711, and can synchronize the management side reservation information 321 with the customer attraction side reservation information by the synchronization controller 712, so that it is possible to prevent double booking of the reservation for the room 20, and to increase certainty of the reservation. Further, since the management server 3 and the customer attraction server 6 do not need to synchronize the reservation information with each other, loads on these servers can be suppressed.

(6) Since the site controller 7 includes the key issuer 713 that issues the unlocking key for unlocking the locking device 22 of the room 20 on the basis of the update of the customer attraction side reservation information, it is possible to issue the unlocking key to a user even for the reservation from the customer attraction server 6 that does not meet the specifications of the locking device 22 of the room 20, thereby widely attracting users regardless of the specifications of the customer attraction server 6.

### Alternative Implementations

Note that the present disclosure is not limited to the above-described implementation, and modifications, improvements, and the like within a range in which an object of the present disclosure can be achieved are included in the present disclosure.

For example, in the above implementation, the management server 3 includes: the business goal information setter 314 that receives the business goals of the room 20 via the manager side terminal device 4, and thus stores and sets the business goal information 323 on the business goals in the management information storage 32; the business goal achievement determiner 315 that determines whether the business goals can be achieved on the basis of the management side reservation information 321 and the business goal information 323 stored in the management information storage 32; and the user group switcher 316 that causes the user group setter 313 to switch the user group on the basis of the determination result of the business goal achievement determiner 315, but they may not be provided.

Further, in the above implementation, the management server 3 includes the reservation information annunciator 312 that announces the management side reservation information 321 stored in the management information storage 32 by the management side reservation manager 311 to the administrator of the room 20. On the other hand, when the management server 3 includes the business goal information setter 314, the business goal achievement determiner 315, and the user group switcher 316 described above, and can automatically switch the user group so that the business goals of the room 20 can be achieved, the reservation information annunciator 312 may not be provided.

In the above implementation, a case in which the room 20 of the building 2 is rented as the on-demand rental facility is exemplified, but the on-demand rental facility is not limited to the conference room, a training room, and the like, and may be a tennis court, a baseball field, a stadium, a parking lot, or the like, which are outdoor spaces, or a karaoke room, a rental office, a reading space, or the like. Further, the on-demand rental facility is not limited to a facility attached to real estate such as the building 2, and may be movable property such as various goods, or a moving object such as an automobile or a ship.

In the above implementation, various functions of the management system 1 for the rental space are distributed and implemented in the management server 3, the customer attraction server 6, and the site controller 7, but any function may be distributed and implemented in any of the management server 3, the customer attraction server 6, and the site controller 7, and the management system 1 for the rental space may be appropriately designed as long as the various functions of the management system 1 for the rental space can be implemented.

In the above implementation, the management server 3, the customer attraction server 6, and the site controller 7 may be configured by a centralized management type server device or may be a distributed management type, for example, a device using a distributed transaction ledger typified by blockchain can be used.

Further, in the above implementation, the management server 3, the customer attraction server 6, and the site controller 7 are separately provided and connected to each other via the Internet 8, but the present disclosure is not limited to this, and the management server 3, the customer attraction server 6, and the site controller 7 may be provided in a single site, or functions of the management server 3, the customer attraction server 6, and the site controller 7 may be implemented by a plurality of devices distributed on the Internet 8.

The foregoing description has been described with reference to specific implementations. However, the illustrative discussions above are not intended to be exhaustive or to limit the claims to the precise forms disclosed. Many variations are possible in view of the above teachings. The implementations were chosen and described to best explain principles of operation and practical applications, to thereby enable others skilled in the art.

The various drawings illustrate a number of elements in a particular order. However, elements that are not order dependent may be reordered and other elements may be combined or separated. While some reordering or other groupings are specifically mentioned, others will be obvious to those of ordinary skill in the art, so the ordering and groupings presented herein are not an exhaustive list of alternatives.

As used herein: the singular forms “a”, “an,” and “the” include the plural forms as well, unless the context clearly indicates otherwise; the term “and/or” encompasses all possible combinations of one or more of the associated listed items; the terms “first,” “second,” etc. are only used to distinguish one element from another and do not limit the elements themselves; the term “if” may be construed to mean “when,” “upon,” “in response to,” or “in accordance with,” depending on the context; and the terms “include,” “including,” “comprise,” and “comprising” specify particular features or operations but do not preclude additional features or operations.

What is claimed is:

1. A management system for an on-demand rental facility, comprising:
a management server that manages the on-demand rental facility;
an administrator input means that is connected to the management server via a communication line and receives information input to the management server by an administrator of the on-demand rental facility; and
a user input means that is connected to the management server via a communication line and receives information input to the management server by a user of the on-demand rental facility, wherein
the management server comprises:
a management side reservation manager that stores and sets management side reservation information on the user and use date and time of the on-demand rental facility in a management information storage by receiving a reservation for the on-demand rental facility via the user input means;
a reservation information annunciator that announces the management side reservation information stored in the management information storage by the management side reservation manager to the administrator of the on-demand rental facility; and
a user group setter that causes the administrator of the on-demand rental facility to set, via the administrator input means, a group of users who are persons eligible for the reservation of the on-demand rental facility to be received via the user input means, and
the group of users comprises:
a first group of users; and
a second group of users different from the first group of users.

2. The management system for the on-demand rental facility according to claim 1, wherein a usage fee of the on-demand rental facility for the first group of users and a usage fee of the on-demand rental facility for the second group of users are different from each other.

3. The management system for the on-demand rental facility according to claim 1, wherein one of the first group of users and the second group of users is a group of subscription users who pay a fee as consideration for usage right for a certain period.

4. The management system for the on-demand rental facility according to claim 1, wherein
the management server comprises:
a business goal information setter that stores and sets, by receiving business goals of the on-demand rental facility via the administrator input means, business goal information on the business goals, in the management information storage;
a business goal achievement determiner that determines whether the business goals can be achieved based on the management side reservation information and the business goal information; and
a user group switcher that causes the user group setter to switch the group of users based on a determination result of the business goal achievement determiner.
